(19) United States
(12) Patent Application Publication
(10) Pub. No.: US 2014/0340712 A1
(43) Pub. Date: Nov. 20, 2014

(54) METHOD FOR SUBMITTING A DOCUMENT STORED IN A FILE REPOSITORY TO A JOB QUEUE OF A REPROGRAPHIC APPARATUS, COMPUTER PROGRAM PRODUCT THEREFOR, AND SYSTEM FOR PRINTING A DOCUMENT STORED IN A FILE REPOSITORY

(71) Applicant: OCE-TECHNOLOGIES B.V., Venlo (NL)

(72) Inventors: Kevin H.R. HOES, Berkel-Enschot (NL); Merijn P. NEELEMAN, Nijmegen (NL)

(21) Appl. No.: 14/449,547

(22) Filed: Aug. 1, 2014

Related U.S. Application Data
(63) Continuation of application No. PCT/EP2013/052150, filed on Feb. 4, 2013.

(30) Foreign Application Priority Data
Feb. 3, 2012 (EP) 12153908.4

(51) Int. Cl. G06F 3/12

(52) U.S. Cl. CPC G06F 3/126; G06F 3/1278; G06F 3/1211
USPC 358/1.15

(57) ABSTRACT

Method for submitting a document stored in a file repository to a job queue of a reprographic apparatus, the method comprising: connecting to a message repository; retrieving from the message repository at least one message; searching the retrieved messages for potential document identifiers and compiling a set of potential document identifiers; connecting to a file repository; checking for each potential document identifier in the compiled set whether a document having a document identifier corresponding to the potential document identifier exists in the file repository; selecting the documents with a document identifier corresponding to a potential document identifier for submission to the job queue of the reprographic apparatus; and submitting the selected documents to the job queue of the reprographic apparatus

The present invention relates to a method for submitting a document stored in a central storage to a job queue of a reprographic apparatus.

The present invention further relates to a computer program product that, if executed on a processor, performs such a method.

The present invention also relates to a data carrier having stored thereon such a computer program product.

Furthermore, the present invention relates to a device executing such a method.

The present invention also relates to a system comprising such a device.

We are living in a world that is rapidly digitising. Information that was formerly exchanged mainly orally or in (physical) writing, such as in print, is more and more often exchanged through digital media such as e-mail, Short Message Service (SMS) messages and social media. However, there is still a market for information in print, although the document is in most cases created in a digital form. It is nowadays also quite common to store these digital documents in central storages taking for example the form of file hosting services offering their services publicly through public networks such as the Internet (examples are Box, Dropbox, Google Drive, iCloud, SkyDrive, and SugarSync). These file hosting services offer methods to share the documents with other users, or even making the documents publicly available. This development is responsible for a shift in exchanging documents, away from technologies as e-mail, towards these file hosting services.

There are however still occasions where a print version of a document is preferable. Due to the fall in costs of digital storage space, the amount of storage space available to users (whether this is a local storage such as a local hard drive or local solid-state drive, or alternatively a remote storage such as the aforementioned file hosting services) has increased enormously in the past years. Therefore, the need for deciding what to store and what not, and whether cleaning up space by removing older documents has diminished significantly. This however, aggravates the problem of finding the correct document in the growing collection of documents when one needs the document, for example when one wants to print a specific document.

The object of the present invention is to alleviate this problem by providing a method for submitting a document stored in a file repository to a job queue of a reprographic apparatus, the method comprising: connecting to a message repository; retrieving from the message repository at least one message; searching the retrieved messages for potential document identifiers and compiling a set of potential document identifiers; connecting to a file repository; checking for each potential document identifier in the compiled set whether a document having a document identifier corresponding to the potential document identifier exists in the file repository; selecting the documents with a document identifier corresponding to a potential document identifier for submission to the job queue of the reprographic apparatus; and submitting the selected documents to the job queue of the reprographic apparatus.

The invention allows to easily send to a printer documents that have been the subject of discussion. By examining messages exchanged potential document identifiers are detected. The detection of potential document identifiers may be implemented by means of pattern recognition techniques, string matching, regular expression matching, semantic analysis of the message text, or similar techniques to recognise specific strings. The potential document identifiers are compared to actual document identifiers of documents stored in a file repository. The file repository may be a local file system, a network accessible file system such as a network drive shared as a Common Internet File System (CIFS), also known as Server Message Block (SMB), or a file hosting service as described above.

Comparing the potential document identifiers to the actual document identifiers may be done through exact string matching, or an inexact match, for example implementing a case insensitivity conversion, or a fuzzy match. Selecting the documents with a corresponding document identifier may comprise selecting only documents resulting from an exact match. However, especially with inexact matching and fuzzy matching, selecting may alternatively comprise selecting multiple documents, wherein the decision to select a document or not is based on the match score. After selection of the documents, the documents are submitted to the reprographic apparatus for subsequent reproduction. Reproduction comprises printing and facsimile transmission.

According to one particular aspect of the invention, the message repository comprises a local message repository, such as a storage comprising SMS messages or a local mailbox.

According to an alternative aspect, the message repository comprises a remote message server. The message server may be an e-mail server, a social media server, a microblog server, or a blog server.

According to a further aspect, retrieving from the message server at least one message comprises retrieving from the message server at least one message from a specific message server account. The specific message server account is the account used to connect to the message server and to obtain access to messages stored in the message server. The specific message server account may be a preconfigured account, or an account selected from a list of preconfigured or predefined accounts.

According to another aspect retrieving at least one message from a specific message server account comprises retrieving at least one message published from a specific message server account. The messages retrieved are the messages that are published using a specific account. The account may be preconfigured or configurable on-the-fly. Published may comprise publishing to a restricted group of users and/or accounts, or alternatively publishing to an unrestricted public. The account used to publish the messages may be the same account as used to connect to the message server according to the present invention, or may be a different account. Furthermore, it may not be necessary to connect to the message server through a specific account in order to retrieve the messages. This is for example the case when the published messages are public.

According to again another aspect retrieving at least one message from a specific message server account comprises retrieving messages accessible from a specific message server account. The retrieved messages may be published from other accounts, but have been made accessible to the account used by the present invention to connect to the message server.

According to a further aspect retrieving from the message server at least one message comprises retrieving the most recently published messages. The most recently published messages may be a fixed number, or alternatively all messages published during a configured period, for example all messages published during the last three days. Furthermore, more complex selection criteria may be used, for example, the messages published during the last week with a maximum of fifty messages (retrieving the fifty most recent messages in that case), but at least the last ten messages when less than ten messages were published during the last week. This example sets a minimum and maximum number of messages used for searching for potential document identifiers.

According to a further aspect connecting to a file repository comprises connecting through a specific file repository account. Specifically, file hosting services typically require users to login through a user account. As an alternative, file may be made publicly available through file hosting services. Although a file repository account is not specifically needed to gain access to the publicly shared documents, it is advantageous to limit the search space, for example by configuring an account to be searched for the actual document identifiers.

According to a further aspect the message server account and the file repository account are a single account providing access to both, the message server and the file repository. Several providers of online services such as social media services and file hosting services are integrating their services and allowing users to sign in to multiple services through a single account.

According to another aspect selecting the documents comprises: manual selection by a user. For exact one-to-one matches between potential document identifiers and actual document identifiers, or at least matching activities resulting in a single actual document identifier with a high match score, it is practical to automatically select the single resulting document and submit it to the reprographic apparatus. However, particularly in the case of inexact matches and fuzzy matches resulting in multiple documents, it is preferable to involve the user in the selection process and present a list of documents matching to some (configurable) degree with potential document identifiers to the user and allow the user to select one or more documents from this list for submission to the reprographic apparatus.

As document identifier any piece of metadata may suffice. However, according to a preferred aspect the document identifier is one of: a file name; and a document title. The document title may be stored as metadata in the document itself, or separately in the file system, or in an additional database. However, the document identifier is not limited to metadata. It is even possible to use (part of) the content of a document to identify a document. Of course this might have a performance impact as documents either full-text searches have to be performed on the documents, or the contents of the documents is required to be indexed.

The present invention may, for example, be embodied in a reprographic apparatus or a mobile device, such as a mobile phone, a tablet computer, or a Personal Digital Assistant (PDA).

In one embodiment according to the present invention a computer program product is provided that, if executed on a processor, performs the above mentioned steps.

In a further embodiment, the present invention provides a data carrier having stored thereon such computer program product.

In one embodiment according to the invention, a device is provided comprising: message retrieval means for retrieving messages from a message repository; message searching means connected to the message retrieval means for searching retrieved messages for potential document identifiers; file repository access means for accessing a file repository through the first communication means; document identifier comparison means connected to the message searching means and the file repository access means for comparing potential document identifiers received from the message searching means to the document identifiers of the documents stored in a file repository; document selection means connected to the document identifier comparison means for selecting documents having document identifiers corresponding to a potential document identifier; document submission means connected to the document selection means for submitting the selected documents to a job queue of a reprographic apparatus. The message retrieval means retrieve messages from the message repository. The message searching means search for potential document identifiers through the messages retrieved by the message retrieval means. File repository access means connect to the file repository to check for the existence of files stored in the file repository, the files having actual document identifiers. Document identifier comparison means compare the potential document identifiers to the actual document identifiers. If a match is found between a potential document identifier and an actual document identifier, the document selection means select the document corresponding to the actual document identifier. Depending on the embodiment, matches may be exact or inexact or fuzzy as described above. A potential document identifier might match with more than one actual document identifier. In one embodiment only document corresponding to the actual document identifier with the highest match score is selected. In an alternative embodiment multiple documents are selected, possibly limited, for example by employing a threshold to the match score, or by only selecting the best n matches, wherein best means the highest match scores. In a further embodiment this automatic selection may be followed by a manual selection, wherein the actual document identifiers of the automatically selected documents are presented to a user, and wherein the user selects one or more documents from this list of automatically selected documents. Finally, the selected documents are submitted to the job queue of the reprographic apparatus.

In a preferred embodiment of the present invention the device comprises a mobile device, such as a mobile phone, a tablet computer, a Personal Digital Assistant, a netbook, or a laptop.

In an alternative embodiment, the device comprises a reprographic apparatus.

In a preferred embodiment the present invention provides a system for printing a document stored in a file repository comprising: at least one of: a message repository comprising a message server for publishing messages; and a file repository for storing a plurality of document; and further comprising a mobile device as described above.

Further advantages and further embodiments of the present invention will be described below referring to the annexed drawings, wherein:

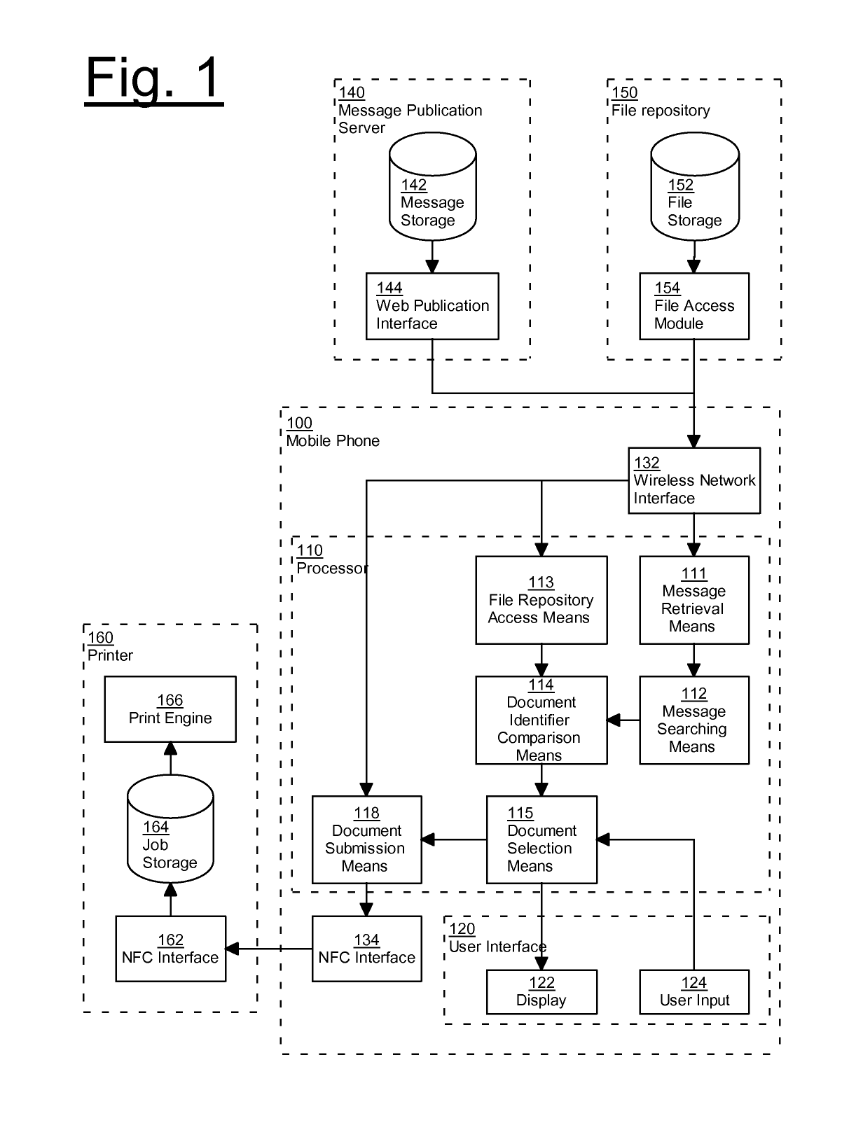

FIG. 1 shows a overview of a system according to the present invention; and

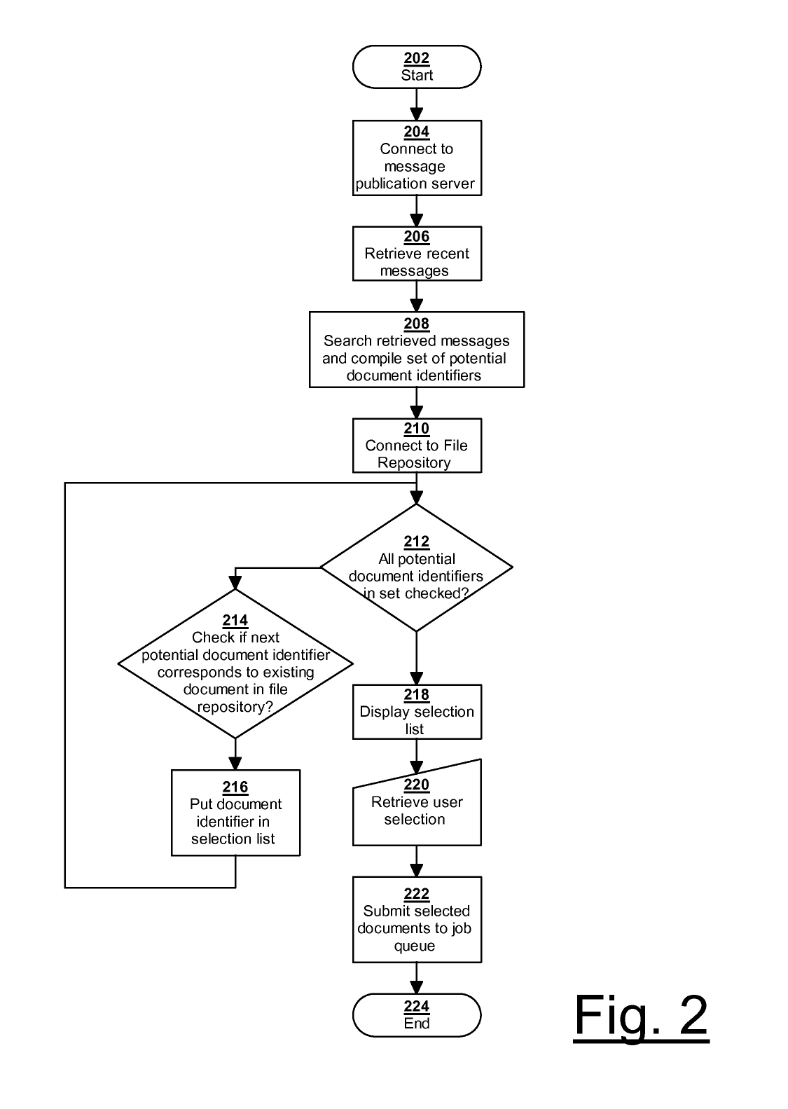

FIG. 2 shows a flow diagram of a method according to the present invention.

A message publication server 140 (FIG. 1) comprises a message storage 142 storing messages written by users of the message publication server 140. The messages stored in the message storage 142 are made available to other users through a web publication interface 144. The web publication interface 144 might employ an access restriction mechanism to determine who is allowed to read what message. Some message may be public, meaning all users maybe even including anonymous users, are able to read these public messages. Other messages may only be accessible to a restricted number of users. For example, only close friends and family of the author of the message. Examples of such message publication servers 140 are blogs, social media such as Facebook and Twitter, discussion boards, forums, etc., but the message publication server 140 may also be a e-mail server or chat server, such as a Jabber server. The web publication interface might be a web user interface accessible by users through a web browser, however, for the invention to function the web publication interface 144 might also be an Application Programming Interface (API), such as a web API. Such a web API might coexist with a web user interface, the former allowing machines to retrieve messages and the latter allowing human beings to access messages.

In addition to the message publication server 140, a file repository 150 exists. The file repository might be integrated with the message publication server 140, but in the present example, they are being presented as two independent services. The file repository 150 comprises a file storage 152, where files, such as documents, are actually stored. The file repository 150 further comprises a file access module 154. Usually, file hosting services provide a file access module 154 in the form of a web user interface allowing human beings to browse the file storage 152 and locate documents to download. For the present invention, it is preferred to have a machine adapted file access module 154 that might optionally coexist with a web user interface for human accessibility. The file access module 154 may for example implement the WebDAV protocol to allow browsing the file storage 152 and retrieve or upload documents.

A mobile phone 100 may be used to connect to the message publication server 140 and the file repository 150, respectively through the web publication interface 144 and the file access module 154. For this connection the mobile phone 100 utilises a wireless network interface 132. Preferably, the wireless network interface 132 implements WiFi and/or a mobile data network such as General Packet Radio Service (GPRS), Edge, Universal Mobile Telecommunications System (UMTS), High Speed Packet Access (HSPA), Long-Term Evolution (LTE), etc. The mobile phone 100 comprises a processor 110 running software to perform various functions, although some functions may be implemented in hardware such as Application Specific Integrated Circuits (ASIC). One of those functions is the message retrieval means 111 that connect through the wireless network interface 132 to the web publication interface 144 to retrieve messages from the message storage 142. The retrieved messages may be all messages accessible through the user account used to connect to the message publication server 140 and that are published over the last say three days. These messages are processed by the message searching means 112. The message searching means 112 analyse the retrieved messages and compile a collection of potential document identifiers. For example, strings that have the structure of a file name (for example a string of alphanumerical characters followed by a full stop and directly followed by a limited number of alphanumerical characters, for example limited to three alphanumerical characters) may be regarded as potential document identifiers. Furthermore, strings such as “Internal Report” followed by an alphanumerical identifier may be regarded as potential document identifiers. Clues about potential document identifiers consists of descriptive words applying to documents such as “document”, “report”, “presentation”, “abstract”, “book”, “article”, “thesis”, “paper”, etc. Such a word might either be preceded by some specific identifier, for example as in “the Winston Report” or might be followed by an identifier, for example “Internal Report 20121207BP”.

The compiled collection of potential document identifiers is being passed to the document identifier comparison means 114. The document identifier comparison means 114 cooperates with the file repository access means 113 to obtain actual document identifiers from the file repository 150. The document identifiers may be file names, but may also comprises other types of metadata such as document titles, document numbers, tags, document summaries, document descriptions. The document identifier comparison means 114 determines matches between the potential document identifiers and the actual document identifiers. These matches may be exact, which is most appropriate for for example file names and document numbers, or inexact, which is more appropriate for document titles, document summaries. For example fuzzy matching may be employed to match document titles.

The document selection means 115 select documents from the file repository 150 that are deemed most relevant, for example by applying a threshold to the matching score. The document selection means 115 may only select a single document corresponding to the actual document identifier that matches a potential document identifier, for example, the document having an actual document identifier with the highest match score. However, the present invention is not restricted as such and the document selection means 115 may select multiple documents corresponding to actual document identifiers matching to a single potential document identifier.

The document selection means 115 presents the selected documents to the user through the user interface 120 by displaying for example the document titles and/or the document file names on the display 122 of the mobile phone 100. The user uses the mobile phone's user input means 124, for example a touch interface of the mobile phone's touch display, to select one or more documents to be submitted to the printer 160. The document submission means 118 receive from the document selection means 115 the document or documents that were selected for submission. The document selection means 115 may pass on the complete selected documents, or the documents may be passed on by reference.

If the selected documents were passed on to the document submission means 118 by reference, the document submission means 118 retrieve the selected documents through the wireless network interface 132 by connecting to the file repository 150. The selected documents are then submitted to the job queue of the printer 160. Document submission may take place through conventional network connections, for example through a WiFi-network interconnecting the mobile phone 100 and the printer 160 (wherein part of the network may be wired instead of wireless). Alternatively, the selected documents are submitted through a Near Field Communication Interface (NFC Interface) 134. This may simplify document submission for the user as it is not necessary to select a printer to submit to, as the NFC Interface will take care of this. For this to function, the printer 160 comprises a NFC Interface 162 too. Submitted documents received are stored in the job storage 164 and queued for printing on the print engine 166.

In order to facilitate printing large documents, the NFC connection may only be used for printer selection and for setting up a secure connection between the mobile phone 100 and the printer 160, the actual document submission (transfer of the document from the mobile phone 100 to the printer 160) taking place through a further connection, for example, running over a WiFi-connection (that may be partly wired, for example from a WiFi-access point to the printer).

The process is also explained based on a flow diagram (FIG. 2). The process starts 202 and connects 204 to the message publication server 140. After connecting a number of messages are retrieved 206 from the message publication server 140. As the message publication server 140 may contain a lot of messages including outdated messages, only a selection of the messages is retrieved. Preferably only recent messages are retrieved. Furthermore, the messages retrieved may optionally be filtered by whom was the author of the messages and/or the users or groups of users the messages are accessible to. The retrieved messages are searched 208 and potential document identifiers are identified. Additionally, the system connects 210 to the file repository 150. It is checked 212 if all potential document identifiers in the collection of potential document identifiers have been matched against the actual document identifiers. If not, a potential document identifier is matched 214 against the actual document identifiers of the documents stored in the file repository 150. As described above, matching may comprise exact matching, but also inexact matching. If a match is found (exact or inexact), the document corresponding to the actual document identifier is selected 216. This process continues until all potential document identifiers have been processed. Then, the documents of the matched actual document identifiers are displayed 218 in a selection list. The user examines the selection list and selects the documents he wants to be printed. After the user selection has been obtained (220), the documents selected by the user are submitted 222 to the job queue of a printer. This ends 224 the document selection and submission process.

In an alternative embodiment, no mobile phone is involved and the functionality of retrieving the messages, searching the messages, matching the potential document identifiers against actual identifiers, selecting documents and submitting the documents to the job queue of the printer, is implemented in the printer 160 itself, or alternatively in a print server. In these embodiments the user uses the user interface of the printer to select the documents that correspond to actual document identifiers that match the potential document identifiers.

The embodiments described above and shown in the drawings are not to be regarded as limitative. They are only presented here as examples of embodiments. The person skilled in the art understands that many modifications and adaptations are possible without departing from the scope of the invention. For example, combining the features of separate embodiments presented here also fall within the scope of the present invention. The scope of protection sought is therefore only limited by the following claims.

1. A method for submitting a document stored in a file repository to a job queue of a reprographic apparatus, the method comprising:
connecting to a message repository;
retrieving from the message repository at least one message;
searching the retrieved messages for potential document identifiers and compiling a set of potential document identifiers;
connecting to a file repository;
checking for each potential document identifier in the compiled set whether a document having a document identifier corresponding to the potential document identifier exists in the file repository;
selecting the documents with a document identifier corresponding to a potential document identifier for submission to the job queue of the reprographic apparatus; and
submitting the selected documents to the job queue of the reprographic apparatus.

2. The method according to claim 1, wherein the message repository comprises a remote message server.

3. The method according to claim 2, wherein retrieving from the message server at least one message comprises retrieving from the message server at least one message from a specific message server account.

4. The method according to claim 3, wherein retrieving at least one message from a specific message server account comprises retrieving at least one message published from a specific message server account.

5. The method according to claim 3, wherein retrieving at least one message from a specific message server account comprises retrieving messages accessible from a specific message server account.

6. The method according to claim 1, wherein retrieving from the message server at least one message comprises retrieving the most recently published messages.

7. The method according to claim 1, wherein connecting to a file repository comprises connecting through a specific file repository account.

8. The method according to claim 7, wherein the message server account and the file repository account are a single account providing access to both, the message server and the file repository.

9. The method according to claim 1, wherein selecting the documents comprises manual selection by a user.

10. according to claim 1, wherein the document identifier is one of:
a file name; and
a document title.

11. The method according to claim 1, executed on one of:
a reprographic apparatus; and
a mobile device.

12. A computer program product embodied on a non-transitory computer readable medium that, if executed on a processor, performs the steps of the method of claim 1.

13. (canceled)

14. A device comprising:
a message retrieval device configured to retrieve messages from a message repository;
a message searching device connected to the message retrieval device and configured to search retrieved messages for potential document identifiers;
a file repository access device configured to access a file repository through a first communication device;
a document identifier comparison device connected to the message searching device and the file repository access device and configured to compare potential document identifiers received from the message searching device to the document identifiers of the documents stored in a file repository;
a document selection device connected to the document identifier comparison device and configured to select documents having document identifiers corresponding to a potential document identifier; and
a document submission device connected to the document selection device and configured to submit the selected documents to a job queue of a reprographic apparatus.

15. The device according to claim 14, comprising one of:
a mobile device; and
a reprographic apparatus.

16. A system for printing a document stored in a file repository comprising:
at least one of:
a message repository comprising a message server for publishing messages;
and
a file repository for storing a plurality of document; and
the device according to claim 14.

17. The method according to claim 2, wherein retrieving from the message server at least one message comprises retrieving the most recently published messages.

18. The method according to claim 3, wherein retrieving from the message server at least one message comprises retrieving the most recently published messages.

19. The method according to claim 4, wherein retrieving from the message server at least one message comprises retrieving the most recently published messages.

20. The method according to claim 5, wherein retrieving from the message server at least one message comprises retrieving the most recently published messages.

21. The method according to claim 2, wherein connecting to a file repository comprises connecting through a specific file repository account.
